(19) United States
(12) Patent Application Publication
(10) Pub. No.: US 2009/0133773 A1
(43) Pub. Date: May 28, 2009

(54) Method for machining metal conduits to form a V-shaped profiled section n pipeline metal pipes; metal conduit; welding method combining in a common laser fusion bath and electric arc for assembling said conduits

(76) Inventors: Gilles Richard, Silly Le Long (FR); Abdelkrim Chehaibou, Metz (FR)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 11/916,282

(22) PCT Filed: Jun. 2, 2006
(86) PCT No.: PCT/FR06/01259

§ 371 Date: Jul. 7, 2008

(30) Foreign Application Priority Data
Jun. 2, 2005 (FR) 0505604

(51) Int. Cl. F16L 9/00; B26D 1/00; B23K 26/00

(52) U.S. Cl. 138/177; 83/13; 219/121.64

(57) ABSTRACT

The invention concerns a method for machining the ends of a metal conduit (1) for forming, when it is abutted with identical conduits, a pipeline pipe, to form at the plane of the parting line (3) with another identical conduit a V-shaped bevel. The invention is characterized in that it consists in cutting the ends of the conduit so that the profile of each end has at least one first cross-section, at the inner edge, designed to constitute part of the root face of the V-shaped bevel and an arc-shaped section linking said cross-section of the profile to a rectilinear section (5) inclined relative to the cross-section of said profile, at the outer edge of the tubular part. The invention is applicable to metal conduits, in particular for pipelines.

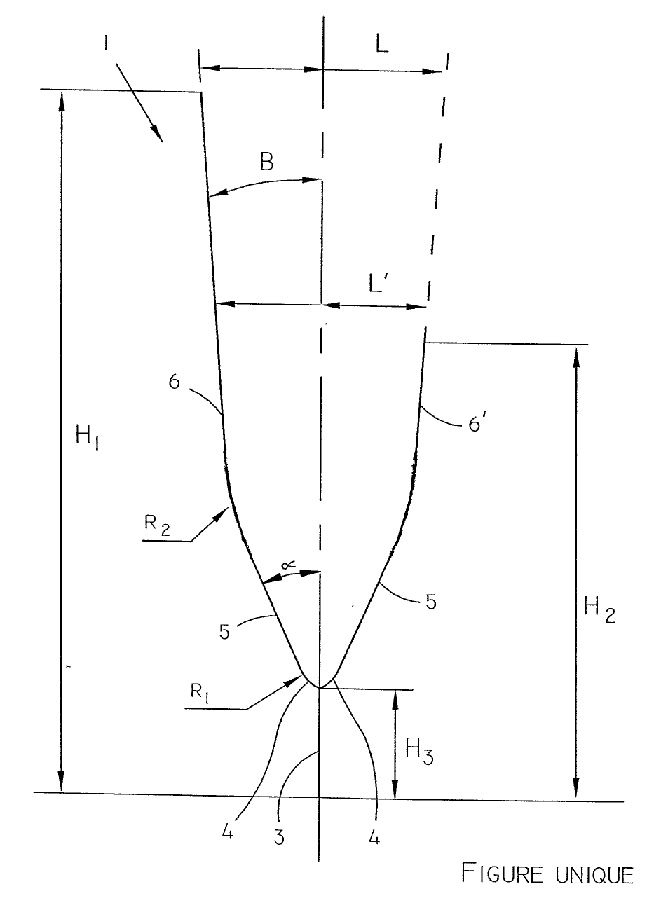

This invention concerns a method for machining metal conduits which, when abutted with identical conduits to be welded, form pipeline type metal pipes, designed to convey oil and gas, as well as a method of welding metal conduits machined according to the machining process.

In order to form pipeline type pipes, it is important for the welding carried out between two conduits to have the qualities required for conveying materials such as oil and gas, the welding therefore avoiding the risk of weakness defects.

To make the weld joint reliably, an electric arc-assisted laser welding process has been proposed, described below as a hybrid laser welding process. However, the different hybrid laser welding processes and devices for their use present numerous problems.

It has thus been observed that, when a hybrid laser welding device is used on conduits without beveled end profiles (abutted) for conduit thicknesses of less than 12 mm, a problem generally arises with centering the laser in relation to the parting plane and with perfect perpendicularity of the torch, the lesser off-centering inducing a lack of penetration and/or a lack of lateral fusion. Furthermore, it is necessary to use a very high laser power generally exceeding 4 kW, which is economically disadvantageous.

When the bevel is with steep V-shaped root face and outer case, there is also a problem of centering the laser beam. Furthermore, a problem arises as soon as the thickness of the ends to be assembled increases and too wide a bevel is difficult to fill with automatic arc welding equipment.

When the bevel is with low incline V-shaped root face and outer case, there is always a problem of centering the laser beam. In addition, the V-shaped bevel being very closed, the electric arc is not stable at the bevel root and risks clinging to a bevel edge in an uncontrolled manner. Furthermore, depending on the quality of centering of the consumable electrode (filler metal), which is never perfect owing to the remnant curvature of the wire, the electric arc will not be centered and will be forced on one of the faces of the bevel, thus creating lateral cavity type defects and lack of lateral fusion, generating a serious problem of reproducibility and, therefore, of quality.

Finally, in a V-shaped bevel the electric arc has a low capacity of interpenetration in the thickness of the root face; this results therefore in a dilution of the non-homogeneous filler metal through the thickness of the fusion bath, the filler metal remaining mainly on the outer part of the bevel.

According to document U.S. Pat. No. 4,213,555, a welding process is known in which for tubes with a thickness of more than 12 mm it is proposed that the bevel be made with a first inclined slope of 25° from the base, followed by a second slope of 5° relative to the parting line. Such a bevel does not contain any root face. However, if a hybrid laser welding process is used with a bevel of such shape, one incurs risks of crossings of the bevel, subsidence of the fusion bath or even joint profile risks in stages if there is a poor alignment of the two tubes.

According to the document “Rational Welding Design” of TGF GAY & J. SPENCE, 1982, Butterwoths & Co. (Publishers) Ltd., Norwich, Norfolk, United Kingdom, page 71, butt-welding is proposed for conduits less than 20 mm thick, the end of which has a profile containing a straight part followed by an inclined part, so as to form a bevel with V-shaped root face and outer case with slope of 30° to 40°, which has the disadvantages mentioned above. That same document proposes making a profile for conduits more than 20 mm thick with a straight part and an inclined section of 10 to 15°, linked by a curved section making it possible to obtain a U-shaped bevel, that curved section well forming a U-shaped bevel, for it is not tangent to the inclined section. Such a U-shaped bevel is also described in the “Welder's Troubleshooting Guide,” 1993, Reston Publishing Company, Inc., Reston, Va., U.S.A., pages 55-56.

In FR 985,513 a conduit profile is proposed which contains a straight part and an inclined part linked by a flat part and a curved part; the bevel thus formed is U-shaped with flat bottom. A problem then exists of centering the laser beam on laser welding with such a bevel. Furthermore, the problem arises as soon as the thickness of the ends to be assembled increases and too wide a bevel is difficult to fill with automatic arc welding equipment.

Conduits whose ends have a profile suitable for forming, when abutted, U-shaped bevels of the same type and, therefore, presenting the same problems as mentioned above are also described in U.S. Pat. No. 2,415,987, JP 48 070639 and GB 656,696.

Both V-shaped and U-shaped bevels have also been proposed, such as those described in JP 56151192. However, laser beam welding problems are encountered with V-shaped and U-shaped bevels.

The object of the invention is to overcome those disadvantages by proposing a method of machining metal conduits which, when abutted to be welded with identical conduits, forms a pipeline type pipe, the machined ends together forming a new kind of bevel making high-speed welding of the penetrating pass possible, notably through a hybrid laser welding process.

For that purpose, the object of the invention is a method of machining the ends of a metal conduit designed to form, when abutted with identical conduits and welded to them, a pipeline type pipe, in order to create at the parting line with another identical conduit a V-shaped bevel, characterized in that the ends of the conduit are cut, so that the profile of each end has at least a first cross section at the inner edge, designed to constitute a part of the root face of the V-shaped bevel and an arc-shaped section linking said cross section of the profile to a rectilinear section inclined relative to the cross section of that profile at the outer edge of the tubular part.

Thus, very advantageously, when machined conduits are abutted according to the method of the invention, the cross section of the end profile of a conduit abuts the cross section of the end profile of the other conduit in order to form the root face of a V-shaped bevel, the tip of which is slightly curved on both sides of the parting line owing to the fact that the two arc-shaped sections and the V-shaped bevel present an opening defined by the end of the inclined sections.

The arc-shaped section is preferably defined so as to be tangent with the inclined rectilinear section and the angle of inclination α is preferably within the range of 15° to 45° relative to the cross section of the end profile, merged with the parting line, so that the width of the bevel at its open end is not more than 10 mm.

A conduit so machined preferably has a thickness of not more than 10 mm and the cross section of the profile has a minimum thickness of 2 mm, in order to ensure machining reproducibility and so that the root face of the bevel formed cannot be pierced on a penetrating pass by a laser beam, for example.

For conduits of greater thickness, the profile can further present a second section inclined by an angle β relative to the cross section of the end profile of the conduit, said angle β being less than the angle α linked to the first inclined section by a second arc-shaped section, so as to always keep the open width of the bevels under 14 mm. The second arc is chosen so as to be tangent to the two inclined sections.

Conduits obtained according to the machining method of the invention are particularly advantageous in the use of a hybrid laser welding process in which the penetrating pass is made on the outside by creating a single fusion bath under the simultaneous action of at least one laser beam transmitted by optical fiber and of at least one gas-protected electric arc generated from a consumable electrode.

In fact, the penetrating pass can be welded at high speed, while obtaining a thickness of the penetrating pass exceeding 4 mm and with a welding bead compactness of excellent quality and reproducible.

Preferably, the cross section of the end profile of the conduits then has a maximum thickness equivalent to 2 mm+a value corresponding to the power in kW of the laser used. This make possible a high welding speed of several meters per minute in penetration phase, while using a laser power of just a few kW and that can, notably, be less than 4 kW, which is economically advantageous.

Preferably, the point of impact of the electric arc is close to the focus point of the laser beam, the gap between the two being called “offset”, that gap being from −5 to 5 mm relative to the focus point of the laser beam.

The arc-shaped parts present at the bevel root afford a tolerance to centering of the laser beam, thus guaranteeing an augmented compactness through less sensitivity to the risk of lack of penetration.

The opening at the top of the first inclined sections of the end profiles of the conduits does not exceed 10 mm, which makes it possible not to have too wide a bevel opening in the part corresponding to the part of the joint welded by the laser process and further makes it possible to obtain a considerable deposited metal height even at high speed. This opening is likewise always greater than 3 mm, so as to avoid high temperature fissuring problems.

A conduit obtained according to the machining method of the invention makes possible the use of a hybrid laser welding process, as mentioned above, with good productivity, while limiting the risk of lack of lateral fusion due to the low welding power used.

Preferably, in the course of the penetrating pass made under the combined action of the laser and electric arc according to that hybrid laser welding process, it is possible to regulate independent of one another the position of the focus point of the laser beam and the gap between the focus point of the laser beam and the position of the point of impact of the electric arc, as well as the angular position of the electric arc welding torch, such as an MIG torch, relative to the laser beam, the MIG torch being shifted at an angle to the laser beam.

The focus point of the laser beam is preferably adjustable within a range of ±5 mm above or below the root face of the bevel, the gap between the focus point and the point of impact of the electric arc can vary within the range from −4 mm to +5 mm on both sides of the focus point of the laser and the angular range within which the MIG torch varies relative to the laser beam is from 5° to 45°.

Depending on the thickness of the ends to be welded, the profile comprises an inclined section, that is, with double inclined section with angle α of the first section greater than angle β of the second section, the bevel opening remaining limited to not more than 14 mm in order to enable the rest of the welding by the electric arc process with fusible wire in narrow bevel configuration, whatever the configuration of the welding head (single and multiple torches).

The presence of the arc-shaped sections at the bevel root makes possible a better interpenetration of the electric arc in the thickness of the root face and a more homogeneous dilution of the filler metal is obtained and, therefore, also more homogeneous mechanical characteristics.

The invention will now be described more in detail with reference to the single figure, which represents a cross-section of the ends of the two conduits made respectively according to two variants of this invention.

As can be seen on the single figure, the left part of the figure corresponds to a conduit 1 with a thickness h₁ and the right part of the figure corresponds to a conduit 2 of thickness less than h₂ to h₁.

The cross section 3 of the end profile of the two conduits 1 and 2 has a height h₃ of 2 mm.

The cross section is followed by an arc-shaped section 4 of radius R₁ identical on the left and right parts of the single figure.

That arc-shaped section 4 serves as a link between the cross section 3 and a rectilinear section 5 inclined relative to the parting line P. The angle of inclination α is represented in the example as 25°.

The inclined section 5 is followed by a second arc-shaped section of radius R₂ which links said inclined section 5 to a second inclined section 6 or 6′. The angle of inclination β of that second section inclined relative to the parting line P is less than α and represented in the example as equal to 5°.

In that way the width L′ of the bevel opening is at most 10 mm in the example represented in the right part of the single figure and the width L is at most 14 mm in the example of the left part.

The invention is, of course, not limited to the examples represented, but covers rather all possible variants.

1. Method of machining the ends of a metal conduit designed to form, when abutted with identical conduits, a pipeline type pipe, in order to form at the parting line with another identical conduit a V-shaped bevel,
characterized in that the ends of the conduit are cut, so that the profile of each end has at least a first cross section at the inner edge, designed to constitute a part of the root face of the V-shaped bevel and an arc-shaped section linking said cross section of the profile to a rectilinear section inclined relative to the cross section of that profile at the outer edge of the tubular part.

2. Method according to claim 1,
characterized in that the arc-shaped section is defined so that it is tangent to the inclined rectilinear section.

3. Method according to claim 1,
characterized in that the angle of inclination α of the inclined section is preferably within the range of 15° to 45° relative to the cross section of the end profile.

4. Method according to claim 1,
characterized in that, for a conduit thickness of not more than 10 mm, the cross section of the profile has a minimum thickness of 2 mm.

5. Method according to claim 1,
characterized in that for a conduit thickness exceeding 10 mm, the profile further has a second section inclined by an angle β relative to the cross section of the end profile of the conduit, said angle β being less than the angle α, linked to the first inclined section by a second arc-shaped section.

6. Method according to claim 5,
characterized in that the second arc-shaped section is made tangent to the two inclined sections.

7. Metal conduit designed to form, when abutted with identical conduits, a pipeline type pipe, in order to form a V-shaped bevel at the parting line with another identical conduit,
characterized in that the ends of the conduit are machined according to the method of claim 1.

8. Welding process for tubular parts such as metal conduits that are abutted to form pipeline type metal pipes, in which the penetrating pass is made on the outside,
characterized in that a single fusion bath is created under the simultaneous action of at least one laser beam transmitted by optical fiber and of at least one gas-protected electric arc generated from a consumable electrode constituting the filler material, the ends of the conduits having been previously machined according to the method of claim 1.

9. Welding process according to claim 8,
characterized in that the penetrating pass is made at a laser power or less than or equal to 6 kW and with an MIG torch of power exceeding 8 kW.
